(19) United States
(12) Patent Application Publication
(10) Pub. No.: US 2025/0306659 A1
(43) Pub. Date: Oct. 2, 2025

(54) PRIORITIZATION OF EXTERNAL POWER SUPPLY THROTTLING FOR CHASSIS MANAGEMENT

(71) Applicant: Dell Products L.P., Round Rock, TX (US)

(72) Inventors: FABRICIO ALMEIDA BRONZATI, São Paulo (BR); DHARMESH M. PATEL, Round Rock, TX (US)

(21) Appl. No.: 18/619,688

(22) Filed: Mar. 28, 2024

(51) Int. Cl. G06F 1/28; G06F 1/26; G06F 1/30

(52) U.S. Cl. CPC G06F 1/28; G06F 1/266; G06F 1/305

(57) ABSTRACT

Methods, systems, and devices for managing performance of workloads by hardware components housed in a power supply free chassis of a rack system are disclosed. To manage the performance, an aggregate power draw of power supplies of a rail mounted power system may be obtained and a maximum power output of a power distribution unit of the rail mounted power system may be identified. Based on the maximum power output and the aggregate power draw, a determination may be made regarding whether the aggregate power draw exceeds the maximum power output. If the maximum power output is exceeded, each chassis that draws power from any of the power supplies may be ranked with regard to one another based on priority rankings to obtain a rank ordering of the chassis.

### FIELD

Embodiments disclosed herein relate generally to management of workload performance by devices in data processing systems. More particularly, embodiments disclosed herein relate to systems and methods for management of external power components for power supply free chassis in a rack system.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a data processing system in accordance with an embodiment.

FIGS. 2A-2D show diagrams illustrating a rack system in accordance with an embodiment.

FIG. 2E shows a data flow diagram illustrating a method for obtaining a risk assessment for a power supply free chassis of a rack system in accordance with an embodiment.

FIG. 2F shows a data flow diagram illustrating a method for external power supply management to enhance workload performance in accordance with an embodiment.

FIG. 2G shows a data flow diagram illustrating a method for identifying workload requirements of a workload in accordance with an embodiment.

FIG. 2H shows a data flow diagram illustrating a method for obtaining a decision for placement of a workload in accordance with an embodiment.

FIG. 2I shows a data flow diagram illustrating a method for monitoring power for occurrences of overdrawn power in accordance with an embodiment.

FIG. 2J shows a data flow diagram illustrating a method for throttling external power supply based on established priorities in accordance with an embodiment.

FIG. 2K shows a data flow diagram illustrating a method for establishing priorities based on a phase of a lifecycle of an inference model that must be used to perform a workload in accordance with an embodiment.

FIG. 3A-3C shows flow diagrams illustrating a method for managing performance of workloads by hardware components housed in a power supply free chassis of a rack system in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing performance of workloads that provide, at least in part, computer implemented services. To provide the services, a data processing system may include any number of hardware components (e.g., storage devices, memory modules, processors, etc.) housed in power supply free chassis for performing the workloads.

To provide the computer implemented services, workloads may be performed by various hardware components of the data processing system. By doing so, these hardware components may facilitate various functionalities of the data processing system (e.g., 100).

To perform the workloads, the hardware components may consume power. For example, the hardware components may consume direct current to perform computations.

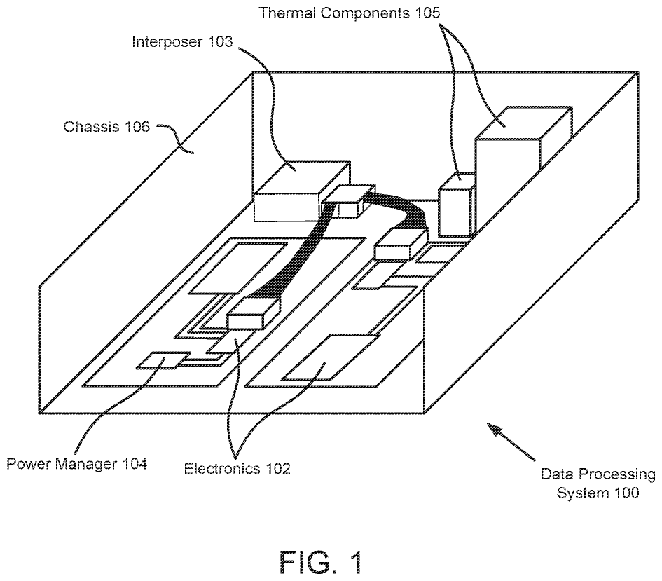

If the hardware components are not provided with sufficient power, then the hardware components may be unable to perform workloads as desired. Consequently, the system of FIG. 1 may be unable to provide the desired computer implemented services.

In general, embodiments disclosed herein relate to systems, devices, and methods for improving the likelihood of data processing systems being able to provide desired computer implemented services. To do so, for example, a power manager of the data processing system may be assessed for power availability, and workload placement decisions to the data processing systems may be made based on the power availability assessments. Consequently, when a workload is placed with a data processing system, the workload may be more likely to be completed.

It will be appreciated that power components such as power supply units may be positioned outside of, and operably connected to, data processing systems. Due to the external placement of the power components, chassis 106 may herein be referred to as a power supply free chassis.

Thus, externally placed power components for providing power to the power supply free chassis may be managed to, for example, optimize performance of workloads facilitated by hardware components dependent on the externally placed power components.

Consequently, when a workload is placed with a data processing system, the workload may be more likely to be completed.

It will be appreciated that power components such as power supply units may be positioned outside of, and operably connected to, data processing systems. Due to the external placement of the power components, chassis 106 may herein be referred to as a power supply free chassis.

Thus, externally placed power components for providing power to the power supply free chassis may be managed to, for example, optimize performance of workloads facilitated by hardware components dependent on the externally placed power components.

In an embodiment, a method of managing performance of workloads that provide, at least in part, computer implemented services is provided, the workloads being performed by hardware components housed in power supply free chassis of a rack system.

The method may include obtaining an aggregate power draw of power supplies of a rail mounted power system; identifying a maximum power output of a power distribution unit of the rail mounted power system; and making a determination, based on the maximum power output and the aggregate power draw, regarding whether the aggregate power draw exceeds the maximum power output; and in a first instance of the determination where the maximum power output is exceeded: ranking, with regard to one another and based on priority rankings, each chassis that draws power from any of the power supplies to obtain a rank ordering of the chassis; identifying, based on the rank ordering, a lowest ranked one of the chassis; and throttling the lowest ranked one of the chassis to prevent the maximum power output from being exceeded to provide computer implemented services using a portion of the chassis; and in a second instance of the determination where the maximum power output is not exceeded: providing the computer implemented services using all of the chassis.

The aggregate power draw may be an instantaneous power demand on the power distribution unit from the power supplies.

A priority ranking of the priority rankings may be based on, at least: workloads being performed by the power supply free chassis; types of the workloads; lifecycle phases of the workloads of at least one of the types of the workloads; and a scoring system usable to quantify a cost for reperforming the workloads.

The scoring system may include associations between different types of the lifecycle phases and different numbers of point values.

The point values may be based on computation costs for performing workloads in the different types of the lifecycle phases.

The at least one of the types of the workloads may be an artificial intelligence workload type.

The lifecycle phases may be one of an enumerated number of phases of artificial intelligence workloads.

The enumerated number of phases may include: a training phase; an inferencing phase; and an updating phase.

Ranking each chassis may include: obtaining a roster of available chassis; obtaining priority ranking; and ordering the chassis based on point values for each chassis using the priority ranking to obtain the rank ordering.

The rack system may be adapted for placement of the power supply free chassis in a high-density computing environment comprising data processing systems.

The rack system may include: a rack for housing at least a portion of the data processing systems and adapted to hold at least one power supply free chassis, and the rack comprising at least one vertical rail; and a rail mounted power system adapted to mount directly to a single vertical rail of the at least one vertical rail.

The rail mounted power system may include: a power distribution unit adapted to obtain rack system level power and distribute, using the rack system level power, power supply level power; and at least one power supply adapted to obtain a portion of the power supply level power and distribute, using the power supply level power, logic level power to the at least one chassis.

In an embodiment, a non-transitory media is provided. The non-transitory media may include instructions that when executed by a processor cause, at least in part, the computer-implemented method to be performed.

In an embodiment, a data processing system is provided. The data processing system may include the non-transitory media and a processor and may, at least in part, perform the method when the computer instructions are executed by the processor.

Turning to FIG. 1, a diagram illustrating a data processing system in accordance with an embodiment is shown. The data processing system shown in FIG. 1 may provide computer implemented services. The computer implemented services may include any type and/or quantity of computer implemented services. For example, the computer implemented services may include data storage services, instant messaging services, database services, and/or any other type of service that may be implemented with a computing device.

To provide the computer implemented services, workloads may be performed by various hardware components of the data processing system. By doing so, these hardware components may facilitate various functionalities of the data processing system (e.g., 100).

To perform the workloads, the hardware components may consume power. For example, the hardware components may consume direct current to perform computations.

If the hardware components are not provided with sufficient power, then the hardware components may be unable to perform workloads as desired. Consequently, the system of FIG. 1 may be unable to provide the desired computer implemented services.

In general, embodiments disclosed herein relate to systems, devices, and methods for improving the likelihood of data processing systems being able to provide desired computer implemented services. To do so, the data processing systems may be assessed for power availability, and workload placement decisions to the data processing systems may be made based on the power availability assessments. Consequently, when a workload is placed with a data processing system, the workload may be more likely to be completed.

To provide the above noted functionality, data processing system 100 of FIG. 1 may include electronics 102, interposer 103, power manager 104, thermal components 105, and/or chassis 106. Each of these components is discussed below.

Electronics 102 may include various types of hardware components such as processors, memory modules, storage devices, communications devices, and/or other types of devices. Any of these hardware components may be operably connected to one another using circuit card traces, cabling, connectors, etc. that establish electrical connections used to transmit information between the hardware components and/or transmit power to the hardware components. For example, electronics 102 may include interposer 103 and/or power manager 104. Each of these is discussed below.

Interposer 103 may route power provided by power components (e.g., power supply units (PSUs)) to electronics 102. To do so, interposer 103 may include an electrical interface that receives power at a first connection (e.g., via some power cables and/or connection pins) and spreads at least a portion of that power to any number of different connections (e.g., leading to the various hardware components of electronics 102).

Although not explicitly shown in FIG. 1, power components such as the PSUs may be positioned outside of, and operably connected to, data processing system 100. Due to the external placement (e.g., with respect to chassis 106) of the power components, chassis 106 may herein be referred to as a power supply free chassis.

For additional information regarding the power components and their placement with regard to data processing system 100, see further below.

Power manager 104 may provide workload placement services for data processing system 100. To provide the workload placement services, power manager 104 may (i) identifying sources of power for data processing system 100 (e.g., PSUs), (ii) assess the health of the sources of the power, (iii) identify responsibilities for supply of power by the sources of power, (iv) obtaining workload requests, (v) identifying power requirements of the workload requests, (vi) using the health of the sources of the power and the responsibilities for the sources of the power to assess whether to accept the workload requests, and (vii) accepting or rejecting workload requests accordingly, assigning workload requests to data processing systems deemed acceptable for performing acceptable workloads, and performing acceptable workloads to contribute to desired computer implemented services provided by the system of FIG. 1.

Power manager 104 may be implemented using hardware and/or software components. For example, power manager 104 may be implemented using a management controller, a microcontroller, and/or other type of programmable logic device that is able to perform the functionality of power manager 104 described herein when so programmed to do so.

Thermal components 105 may thermally manage any of the hardware components of data processing system 100. For example, thermal components 105 may include fans, heat sinks, and/or other types of devices usable to thermally manage the hardware components as operation of the hardware components generates heat.

Any of the hardware components (power components excluded) of data processing system 100 may be positioned within an interior of chassis 106. For example, chassis 106 may include an enclosure in which physical structures of electronics 102 (e.g., processors, memory, power manager 104, etc.), interposer 103, and/or thermal components 105 (e.g., fans, heat sinks, etc.) may be positioned.

For example, to provide its functionality, chassis 106 may be implemented with a form factor compliant (e.g., a ½U sled) enclosure usable to integrate data processing system 100 into a high-density computing environment, such as a rack mount chassis management system (herein referred to as a “rack system”).

Therefore, chassis 106 may facilitate placement and management of electronics 102 and/or other components in a computing environment (e.g., the power components, mentioned previously). For example, to facilitate placement and management of PSUs for providing power to data processing system 100, chassis 106 may be positioned in a rack of the rack system, and operably connected to a rail mounted power system integrated with a single vertical rail of the rack system.

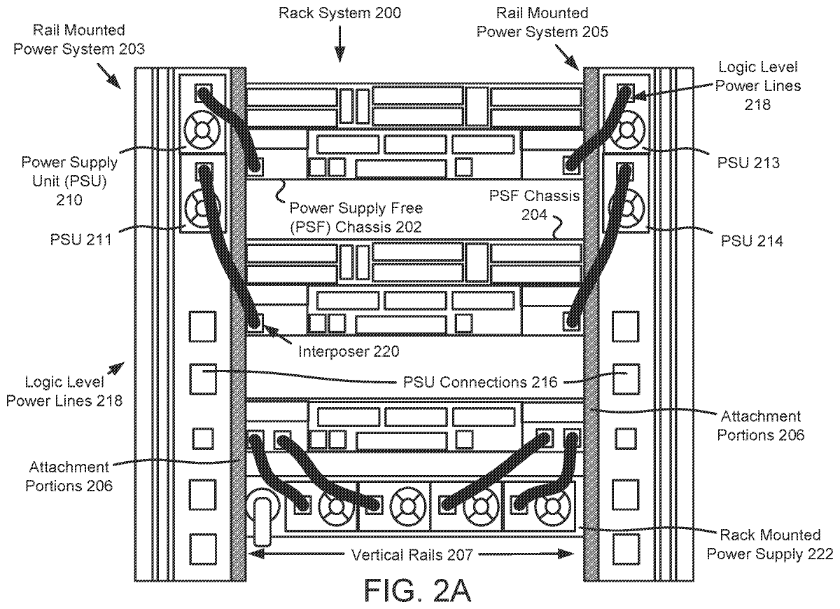

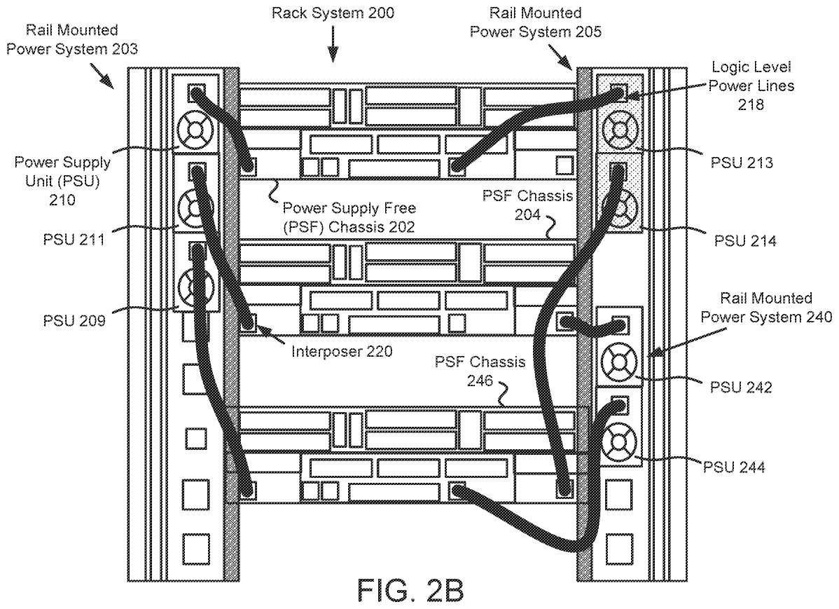

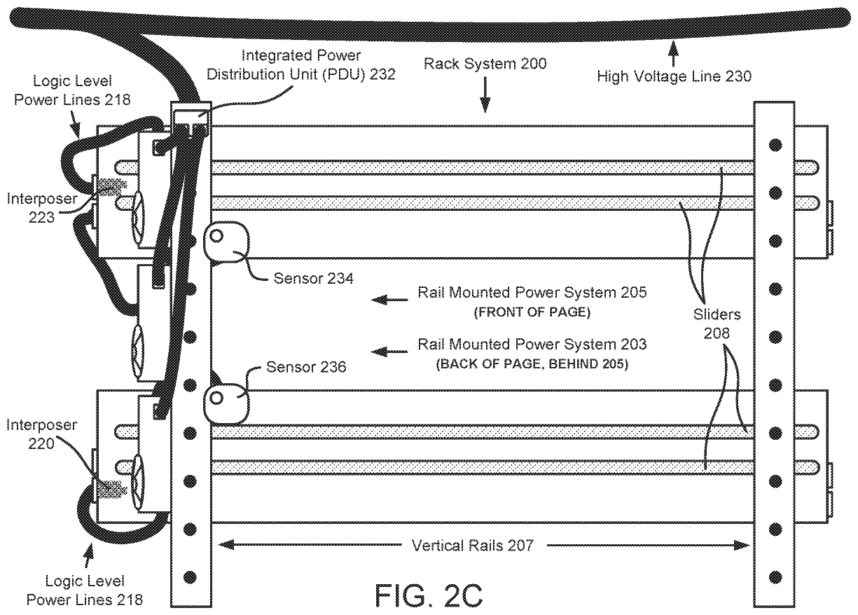

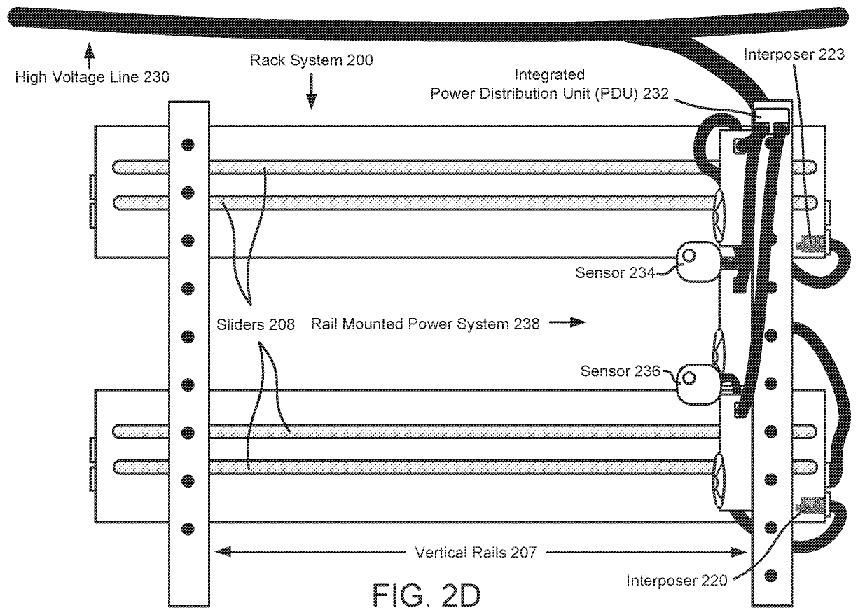

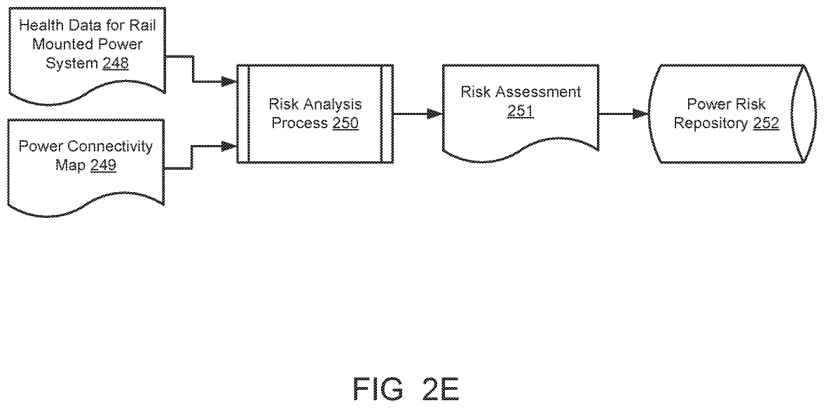

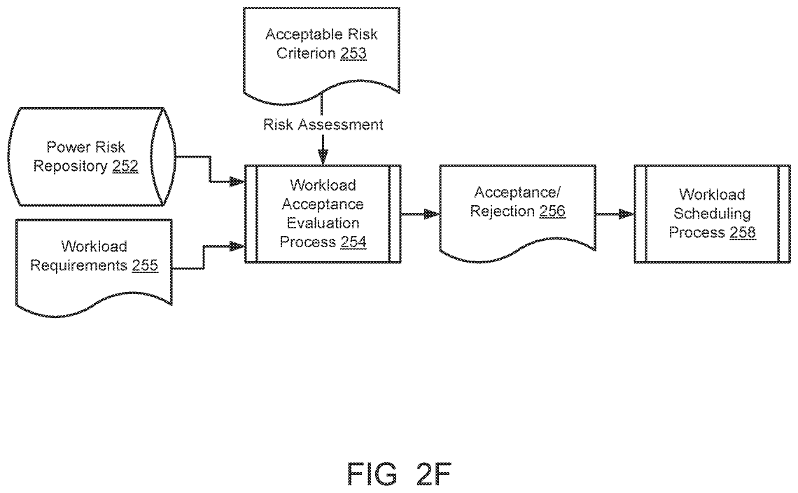

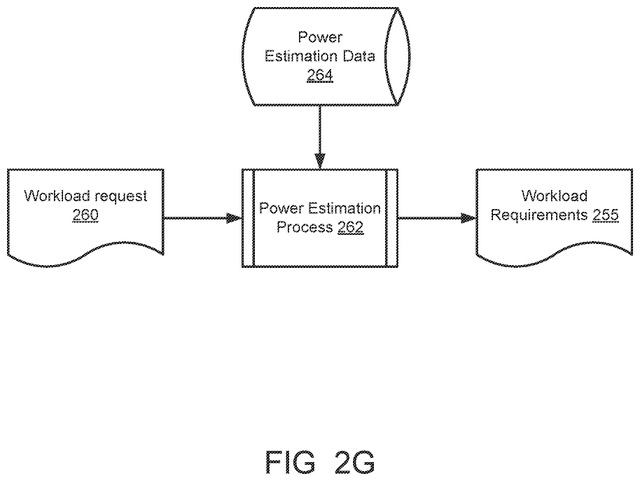

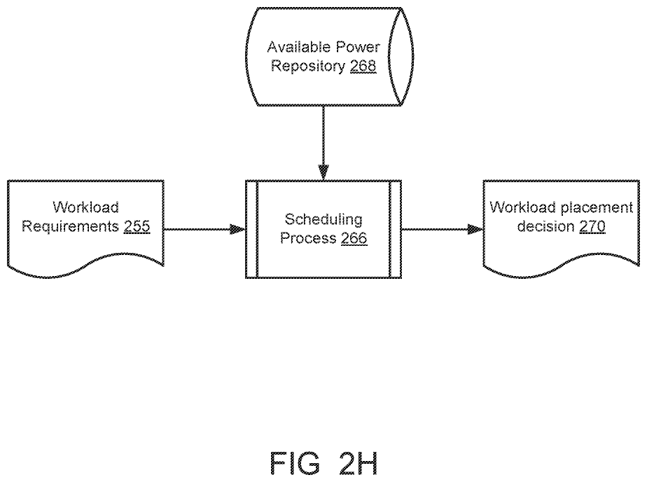

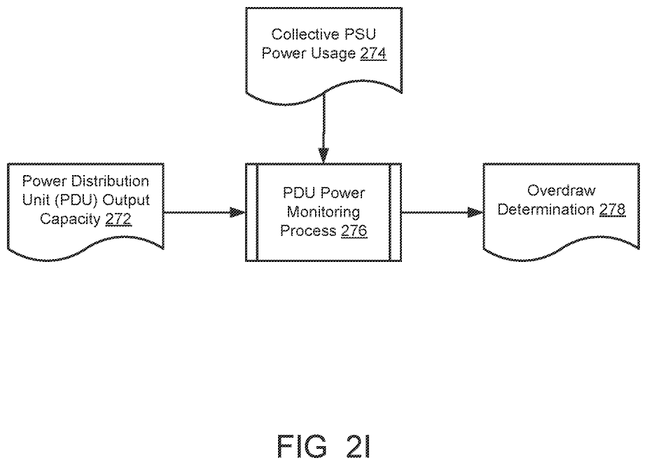

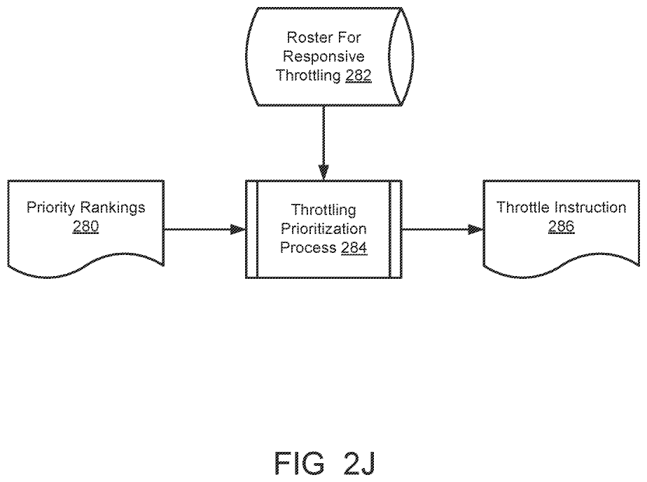

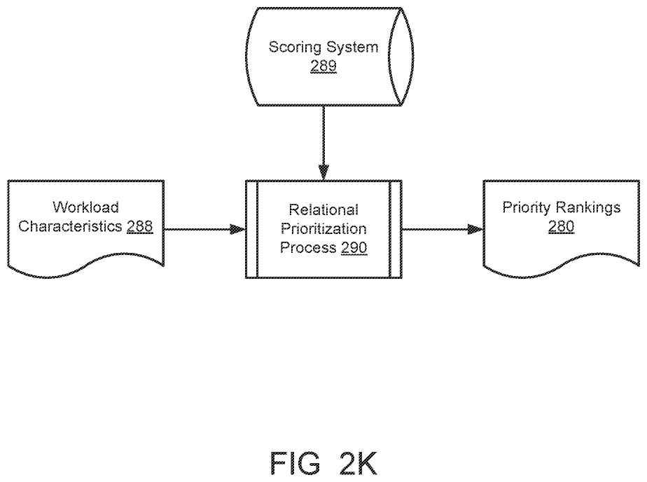

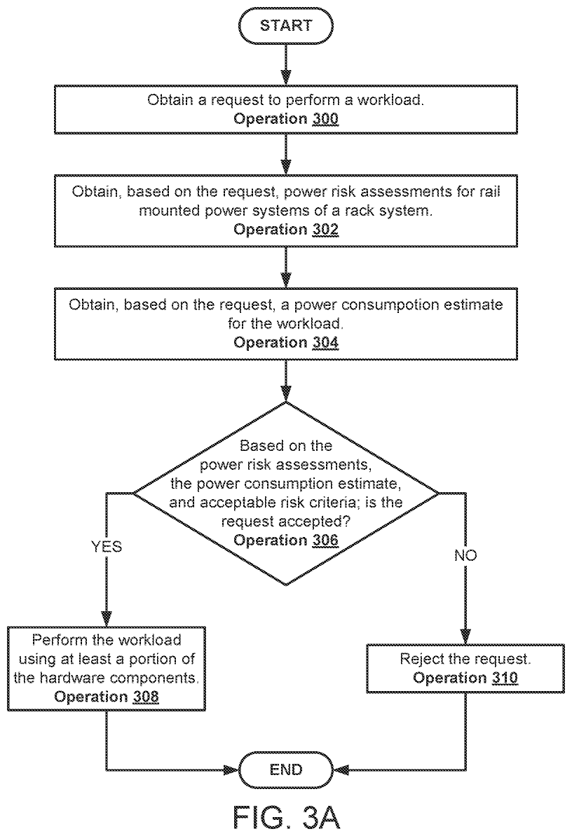

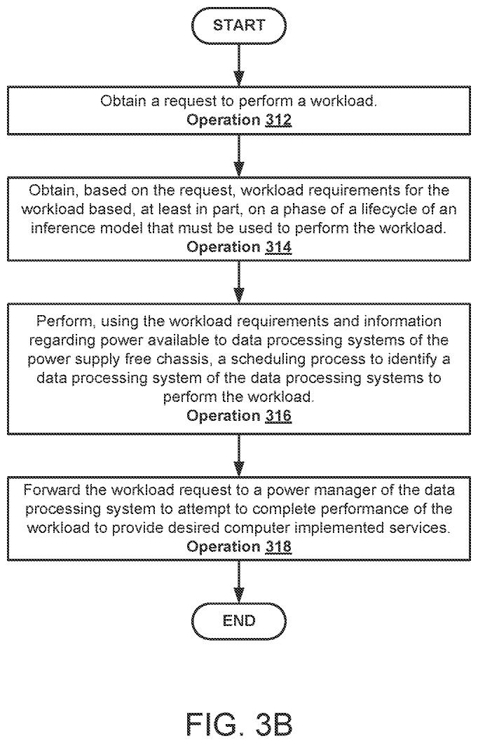

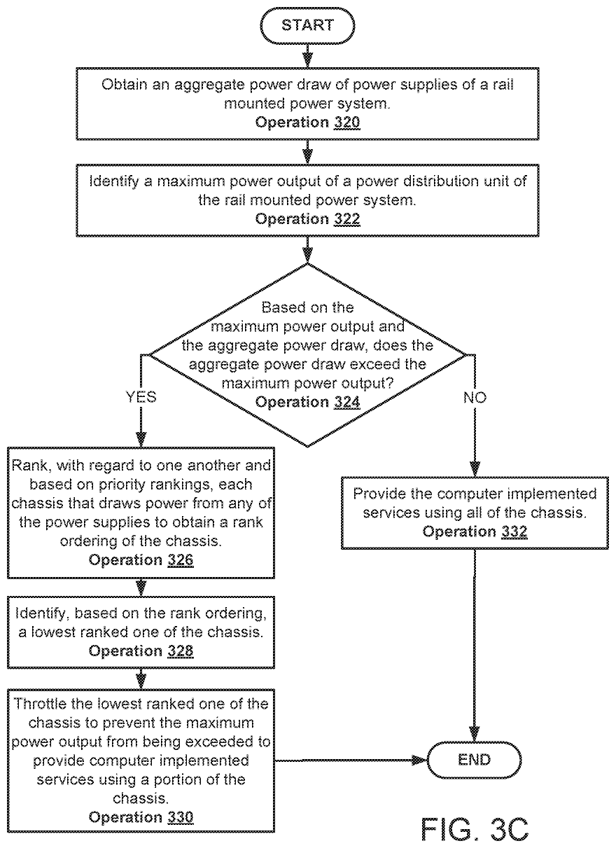

Refer to FIGS. 2A-2D below for additional detail regarding the rail mounted power system, rack system, and/or power supply free chassis (e.g., 106). Refer to FIGS. 2A-3B below for additional detail regarding power management for enhancing workload performance.

Thus, by managing power (e.g., by assessing power availability) and making workload placement decisions based on, for example, the power availability assessments, the likelihood of data processing systems being able to provide desired computer implemented services may be improved. Therefore, and as previously mentioned, when a workload is placed with a data processing system, the workload may be more likely to be completed.

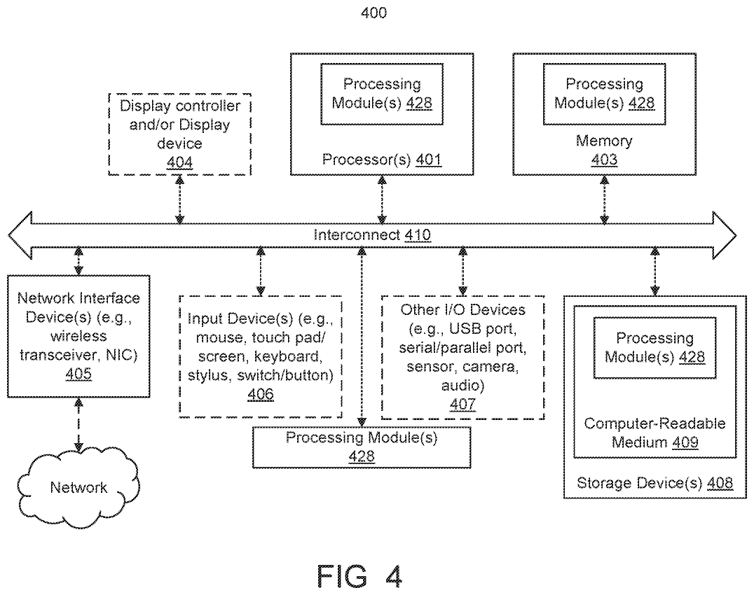

Data processing system 100 (and/or components of a rack system in which data processing system 100 is positioned) may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

While illustrated in FIG. 1 with a limited number of specific components, a data processing system may include additional, fewer, and/or different components without departing from embodiments disclosed herein.

As noted above, the data processing system of FIG. 1 may include a power supply free chassis due to a lack of power components positioned within the interior of chassis 106. Additionally, the data processing system of FIG. 1 may be placed with a rack of a rack system and provided power using a rail mounted power system integrated with a singular vertical rail of the rack system.

FIGS. 2A-2D show diagrams illustrating examples of power supply free chassis positioned with a rack system that includes a rail mounted power system in accordance with an embodiment.

Turning to FIG. 2A, a first diagram illustrating a rack system (e.g., 200) in accordance with an embodiment is shown. The viewpoint of FIG. 2A may be of a rear side of rack system 200, the viewpoint being from directly behind the rack system and facing a same direction as a front side on the rack system.

This rack system may allow for compact and organized storage (e.g., placement) of any number of chassis (e.g., data processing systems), thereby allowing utilization of various systems to provide the computer implemented services.

To provide its functionality, the rack system may include power supply free (PSF) chassis 202 and 204, and rail mounted power system 203 and 205. Each of the two chassis may be positioned on a rack of the rack system. For example, the rack system may further include attachment portions 206 that are lined up along a vertical axis of vertical rails 207, where each attachment portion of attachment portions 206 may be used to fixedly attach a PSF chassis to the rack.

The rail mounted power systems may each be mounted to a respective single vertical rail of the rack system. For example, rail mounted power system 203 may include power supply unit (PSU) 210 and 211, and rail mounted power system 205 may include PSU 213 and 214. As previously discussed, power supply units (PSU's) may be positioned outside of a chassis, resulting in a PSF chassis (e.g., PSF chassis 202 and/or 204). To facilitate this positioning, rack system 200 may include any number of connections such as PSU connections 216. For example, PSU 210-214 may be operably connected to various connections of PSU connections 216 to be provided power transmissions (e.g., “power supply level power”, discussed further below) facilitated by rail mounted power systems 203 and 205. PSU 210-214 may, in turn, provide the power transmissions further along the rail mounted power systems as “logic level power” (discussed further below) to at least a portion of the hardware components and/or additional hardware resources.

To provide their functionalities, PSU connections 216 may be implemented by sockets formed along the rails of rack system 200 that include operable connections for various power transmissions to be facilitated between the rail mounted power systems and any chassis positioned in a rack of rack system 200. In some cases, PSU connections 216 may only restrict movement of a PSU to a limited portion of the exterior by facilitating fixed attachments between each of the PSU and corresponding connections of PSU connections 216. Thus, PSU connections 216 may facilitate various levels (e.g., various degrees) of attachment between each of the PSU and the rail mounted power systems.

Regardless of what level of attachment may be facilitated by PSU connections 216 (so long as the operable connections are facilitated), logic level power lines 218 may direct the power transmissions for the hardware components and/or the additional hardware resources, mentioned previously. For example, logic level power lines 218 may operably connect directly and/or indirectly (e.g., via PSU connections 216) to a PSU of the PSU's. In doing so, logic level power lines 218 may provide a path through which the power transmissions may traverse during operation of either chassis.

To provide their functionality, logic level power lines 218 may be implemented by cabling, connectors, etc. that establish electrical connections used to transmit power to the hardware components and/or the additional hardware resources.

However, the power transmitted via logic level power lines 218 may have an alternating current (AC) (e.g., may be AC power), and therefore may not be natively usable by the hardware components and/or the additional hardware resources. To modify the power transmission so that the hardware components and/or the additional hardware resources may natively use the power, the power transmission may be passed through one or more interposers (e.g., 220).

For example, some of logic level power lines 218 may direct power transmissions from PSU 211 of rail mounted power system 203, through interposer 220, and to the hardware components and/or the additional hardware resources. In doing so, the hardware components and/or the additional hardware resources may natively use the power output from interposer 220, interposer 220 modifying the power transmission to output a direct current (DC) rather than an AC.

To modify the power from an AC to a DC, interposer 220 may route power from the PSU 211 to at least a portion of the hardware components and/or the additional hardware resources (e.g., electronics 102, discussed previously). For example, interposer 220 (e.g., 107 in FIG. 1) may include an electrical interface that receives power at a first connection (e.g., via some power cables and/or connection pins operably connected to at least a portion of logic level power lines 218) and spreads at least a portion of that power to any number of different connections (e.g., that lead to the various hardware components of, for example, electronics 102, and/or the additional hardware resources).

By integrating PSU 211-214 as shown in FIG. 2A, rail mounted power system 203 and 205 may provide power management in a more efficient manner than, for example, rack mounted power supply 222.

For example, to integrate rack mounted power supply 222 with rack system 200, rack mounted power supply 222 may require placement in a position (e.g., in a rack, and/or in at least a portion of collective positions otherwise referred to as “available chassis space”) normally usable by various chassis integrated with rack system 200 to provide computer implemented services.

However, by positioning rack mounted power supply 222 in the position, the available chassis space in rack system 200 may be limited. Consequently, the quantity of chassis capable of being positioned with the rack system may be limited. By limiting the quantity of chassis (and therefore, hardware components therein), a quality, quantity, and/or type of the various functionalities on which the computer implemented services depend may also be limited. Thus, a quality, quantity, and/or type of the computer implemented services may be limited by the limited available chassis space provided by rack system 200.

By using rail mounted power systems, rather than rack mounted power supply, Power components may provide power to the interior of PSF chassis (from an exterior of the PSF chassis) without limiting a quality, quantity, and/or type of the computer implemented services.

For additional information regarding management of power transmissions, refer to FIGS. 2B-3B.

Turning to FIG. 2B a second diagram illustrating a rack system (e.g., 200) in accordance with an embodiment is shown. The viewpoint of FIG. 2B may be of a rear side of rack system 200, the viewpoint being from directly behind the rack system and facing a same direction as a front side on the rack system.

As discussed above, when making workload placement decisions, the health and other characteristics of rail mounted power systems that supply power to electronics in chassis may be considered. To do so, the level of redundancy, responsibility, and health of the rail mounted power systems may be monitored and used in such decisions.

To monitor the redundancy of power being supplied to chassis, the power managers of each of the chassis may (i) identify the power supplies and host rail mounted power systems that supply power to the chassis, (ii) distribute the obtained information to other power managers, and (iii) update a power connectivity map using the obtained information. The power connectivity may indicate which chassis are powered by corresponding power supplies of rack mounted power systems. Thus, the reliance on each power supply of the rack mounted power systems may be identified.

For example, in FIG. 2B and as previously discussed, rack system 200 may include rail mounted power systems 203 and 205. Additionally, rack system 200 may further include rail mounted power system 240, with which PSU 242 and 244 may be positioned. Rack system 200 may also include a third PSF chassis such as PSF chassis 246, and rail mounted power system 203 may further include PSU 209.

Each PSU positioned with a rail mounted power system may be operably connected to any of the chassis to provide power, at least in part, to the operably connected chassis. For example, PSU 242 may be operably connected to PSF chassis 204 while PSU 244 may be operably connected to PSF chassis 246.

It will be appreciated that any of the chassis may be redundantly powered by multiple rail mounted power systems. For example, PSF chassis 246 may be redundantly powered by rail mounted power systems 203, 205, and 240. More specifically, PSF chassis 246 may be redundantly powered by PSU 209, 214, and 244. Additionally, for example, PSF chassis 204 may be redundantly powered by PSU 211 and 242, and PSF chassis 202 may be redundantly powered by PSU 210 and 213.

Additionally, it will be appreciated that any of the rail mounted power systems may power multiple PSF chassis. To do so, a rail mounted power system may be simultaneously and operably connected to the multiple PSF chassis. For example, rail mounted power system 240 may power PSF chassis 204 and 246, rail mounted power system 205 may power PSF chassis 202 and 246, and/or rail mounted power system 203 may power PSF chassis 202, 204, and 246.

By having redundant power, chassis may perform workloads with a decreased likelihood of interruption. For example, assume a malfunction occurs with rail mounted power system 205. This malfunction may delay and/or prevent PSU 213 and 214 entirely from providing sufficient power to a chassis. However, because of redundant power that was available to PSF chassis 202 and 246, rail mounted power system 203 may increase power output to provide sufficient power to both PSF chassis 202 and 246, and rail mounted power system 240 may increase power output to provide sufficient power to PSF chassis 246.

Thus, the level of redundancy may be indicated by the power connectivity map.

To monitor the responsibility of the power supplies, the power connectivity map and the states of the rail mounted power supplies may be used to ascertain the level of responsibility on each rail mounted power system. For example, prior to the malfunction mentioned above, and assuming that rail mounted power systems 203 and 205 were in similar if not a same state, rail mounted power system 203 may have had an equal level of responsibility as rail mounted power system 205. However, post malfunction, the level of responsibility may increase for rail mounted power system 203 due to PSF chassis 202 having a complete reliance on rail mounted power system 203 for power to operate. Similarly, a responsibility level of rail mounted power system 240 may increase, however, not as much as rail mounted power system 203 due to there still being redundant power available to PSF chassis 246 post-malfunction.

By monitoring the level of responsibility, a decision regarding what hardware components may be better equipped to perform specific workloads without exceeding workload capacity (e.g., when no additional work may be performed on top of already performing workloads).

To monitor the health of the rail mounted power systems, the power managers of each of the chassis may (i) receive information regarding the health of each rail mounted power system that supplies power to the chassis, (ii) distribute the obtained information to other power managers, and (iii) update the connectivity map. For example, health of a rail mounted power system may be self-reported (e.g., may be provided by the rail mounted power system) to power managers of corresponding chassis, and the power managers take this information into account when making workload decisions.

By monitoring the health of the rail mounted power systems, additional information regarding a rail mounted power system (e.g., temperature, maximum power output, available power, average power consumption) may be used to define the rail mounted power system's workload capacity.

Using the above information, workload placement decisions may be made that are more likely to result in timely serviced workloads, and less likely to be interrupted. For example, the workload placement decisions may preferentially cause workloads to be placed with chassis that are (i) serviced by lower responsibility rack mounted power systems, and (ii) are serviced by rack mounted power systems that have higher health status. Consequently, the health and/or responsibilities of the rack mounted power systems may be less likely to cause workloads to be, for example, paused, aborted, etc. due to lack of power being supplied to a host chassis.

Turning to FIG. 2C, a third diagram illustrating the rack system (e.g., 200) in accordance with an embodiment is shown. The viewpoint of FIG. 2C may be from a right side of the rack system, the rear side facing a left of the page and the front side facing a right of the page.

As discussed above, components of rail mounted power system 203 and/or 205 (e.g., PSUs 210-214, logic level power lines 218, interposer 220 (and/or 223), integrated power distribution unit (PDU) 232, high voltage line 230, and/or other components) may be used to manage power provided for the PSF chassis. For example, these components, at least in part, may modify at least a portion of the power transmission provided to either PSF chassis (e.g., 202 and/or 204) for powering the hardware components. Thus, operation of the PSF chassis may be enabled.

For example, assume a power providing service directs a power transmission towards a location at a client's request. This power transmission may be transmitted a distance away from the power providing service via powerlines (e.g., high voltage line 230), and thus, may be provided with an alternating current (AC) for efficient transit to the requested location. When this power transmission reaches the requested location, rail mounted power system 205, for example, may obtain the AC (referred to as “rack system level power” at this point of the power transmission) via high voltage line 230.

To do so, the AC may be directed through high voltage power line 230 towards PDU 232 of rail mounted power system 205. PDU 232 may (i) obtain the AC, and (ii) distribute the power transmission to a number of power supply units integrated with rail mounted power system 205 (e.g., 213-214). In doing so, PDU 232 may modify the rack system level power to provide “power supply level power”, mentioned previously with regard to FIG. 2A.

As rail mounted power system 205 continues to facilitate the power transmission, the logic level power may be provided to interposer 220 where the AC of the power transmission is modified to provide a DC to the hardware components (the DC of the power transmission thereby enabling the native usability of the power transmission by the hardware components.

To further manage power provided for the PSF chassis, the rail mounted power systems may further include sensors (e.g., 234 an/or 236, previously mentioned with regard to FIG. 1). These sensors may be used, at least in part, for safety processes regarding power transmissions. For example, the sensors may be used as part of a method for decreasing a likelihood of compromise of the hardware components and/or compromise of workload performance caused by an interruption of power transmissions.

For example, assume the client of the power providing service is at the requested location to provide regularly scheduled maintenance for rack system 200. To service PSF chassis 202 (the top PSF chassis), the client may slide PSF chassis 202 along sliders 208 (to the right of the page) in order to pull PSF chassis 202 out of rack system 200 from the front side of rack system 200. However, rail mounted power systems 203 and 205 may still be operably connected to PSF chassis 202 by logic level power lines 218.

Consequently, as PSF chassis 202 is pulled an unacceptable distance (e.g., a distance that is longer than the maximum distance in which logic level power lines 218 may extend safely and without disconnecting) out through the front side, the logic level power lines 218 may break and/or otherwise disconnect, thereby interrupting any power transmissions being directed to PSF chassis 202.

Such interruption of power allows for compromise of data processing systems of the rack system. For example, the compromise may include data loss or corruption and/or an electrical shortage, leading to a power spike, thereby causing damage to the PSUs, the hardware components, the additional hardware resources, and/or other components.

To decrease a likelihood of the compromise caused by an interruption of power transmissions, the sensors (e.g., 234 and/or 236) may be used to identify whether the power supply free chassis is positioned in an acceptable position. For example, the power components may be adapted to limit distribution of power while the power supply free chassis is not in the acceptable position. For example, the acceptable position may be any position that is a distance shorter than the maximum distance, mentioned previously.

For additional information regarding the sensors, refer to FIG. 2D, below.

Turning to FIG. 2D a fourth diagram illustrating the rack system (e.g., 200) in accordance with an embodiment is shown. The viewpoint of FIG. 2D may be the same viewpoint as shown in FIG. 2C.

As noted previously, the rail mounted power system may be mounted on any single vertical rail of the rack enclosure. For example, the rail mounted power system may be integrated with rack system 200 in various ways as shown in FIGS. 2A-2D.

For example, while mounted on vertical rails 207 in FIG. 2C (rails on a rear side of rack system 100), rail mounted power systems 203 and 205 may also be mounted on vertical rails that are on a front side of rack system 200 (e.g., 238), as shown in FIG. 2D.

Thus, a rack system may include the components discussed in FIGS. 2A-2D, a rail mounted power system being mounted to a single vertical rail of the rack system, and the rack system may use the mounted rail mounted power system to manage power for a power supply free chassis of a data processing system.

To further clarify embodiments disclosed herein, data flow diagrams in accordance with an embodiment are shown in FIGS. 2E-2K. In these diagrams, flows of data and processing of data are illustrated using different sets of shapes. A first set of shapes (e.g., 248, 249, etc.) is used to represent data structures, a second set of shapes (e.g., 250, etc.) is used to represent processes performed using and/or that generate data, and a third set of shapes (e.g., 252, etc.) is used to represent large scale data structures such as databases.

To further clarify embodiments disclosed herein, data flow diagrams in accordance with an embodiment are shown in FIGS. 2E-2K. In these diagrams, flows of data and processing of data are illustrated using different sets of shapes. A first set of shapes (e.g., 248, 249, etc.) is used to represent data structures, a second set of shapes (e.g., 250, etc.) is used to represent processes performed using and/or that generate data, and a third set of shapes (e.g., 252, etc.) is used to represent large scale data structures such as databases.

Turning to FIG. 2E, a first data flow diagram in accordance with an embodiment is shown. The first data flow diagram may illustrate data used in, and data processing performed in, assessing risk (e.g., a level of risk that ranges from low risk to high risk) associated with power usage/consumption for performing workloads. For example, and based on the assessment, a high risk associated with power provided to a data processing system may indicate a high likelihood of compromise of the data processing system. For example, the high risk may be associated with an increased likelihood of shortages, power surges, and/or other electrical failures resulting in an inability to provide hardware components of the data processing system with power. Consequently, without power, the hardware components may be unable to perform the workloads.

To decrease the likelihood of compromise of the hardware components, risk assessments (e.g., 251) may be obtained for (at least a portion of) the external power supplies with regard to each workload requiring processing. Each of these risk assessments may provide an indication of a likelihood of compromise of the hardware components and/or respective workloads, the compromise posing a threat to the performance of workloads.

To obtain the risk assessments, health data (e.g., the health discussed with regard to FIG. 2B) for rail mounted power system 248 and power connectivity map 249 (discussed previously) may be used in risk analysis process 250.

Power connectivity map 249 may be implemented with a data structure specifying what power components are attached (for operable connections) to what hardware components. Therefore, a power component of the power components may power a limited number of the hardware components.

Health data for rail mounted power system 248 may include, but is not limited to, various health states of the power components attached to a single vertical rail. These health states may include but are not limited to temperature, a date of manufacture, a minimum power output, a maximum power output, available power, average power consumption over time, and an average deterioration rate for component efficiency since the date of manufacture.

Once obtained, health data for rail mounted power system 248 and power connectivity map 249 may be used as input for risk analysis process 250. By doing so, risk analysis process 250 may output risk assessment 251. Assuming risk assessment 251 is a single assessment (e.g., rather than a collection of assessments), risk assessment 251 may be placed in power risk repository 252 and/or another type of available storage space.

Power risk repository 252 may be used for making determinations regarding how the workloads may be managed. For additional information regarding how the workloads may be managed based on power risk repository 252, refer to FIG. 2F, below.

Turning to FIG. 2F, a second data flow diagram in accordance with an embodiment is shown. The second data flow diagram may illustrate data used in, and data processing performed in, management of performance of workloads.

To manage the performance of the workloads, workload acceptance process 254 may be performed. During workload acceptance process 254, new requests for workloads may be evaluated to determine whether to accept or reject the requests. To make the determinations, (i) workload requirements 255 for a workload may be obtained, (ii) acceptable levels of risk for the workload may be obtained, (iii) for a data processing system that may service the request, information regarding the health and level of responsibility of the rack mounted power systems that supply power to the data processing system may be obtained, (iv) the aforementioned information may be analyzed to identify whether the data processing system present an acceptable of risk for the workload, and (v) the determination may be made based on whether the risk is acceptable or unacceptable.

To obtain workload requirements 255, the request for performing the workload may be analyzed. The analysis may yield workload requirements 255. Workload requirements 255 may indicate a quantity of power, a duration of time, and/or other requirements of performing a workload.

To obtain acceptable levels of risk for the workload, the acceptable levels of risk may be read from storage, may be obtained from another device, may be dynamically generated, and/or via other methods. For example, to obtain the acceptable levels of risk from storage, a lookup data structure may be stored in the storage. The lookup data structure may associate different types of workloads with different levels of acceptable risk. The type of the workload may be used as a key to perform a lookup in the lookup data structure. Once obtained, the acceptable levels of risk may be stored in memory and/or storage as acceptable risk criterion 253.

To obtain the health and level of responsibility for rail mounted power systems that supply power to the data processing system, power risk repository 252 may be queried. To query the power risk repository 252, an identifier for the data processing system may be provided. Power risk repository 252 may return the level of responsibility and health in response to the query.

To analyze the aforementioned information, a relative level of risk may be obtained. To do so, the relative level of risk may be read from storage, obtained from another device, dynamically generated, and/or obtained via other methods.

For example, the relative level of risk may be dynamically generated by ingesting the level of responsibility, the health, and the workload requirements into a formula, inference model, or other type of entity that may provide the relative level of risk as a function of this aforementioned information.

To determine whether the relative level of risk is acceptable, the relative level of risk may be compared to the acceptable levels of risk. If the relative level of risk is within the acceptable levels of risk, the request may be accepted. Otherwise, the request may be rejected. The outcome of the determination may be stored as acceptance/rejection 256.

Once acceptance/rejection 256 is obtained, workload scheduling process 258 may be performed. During workload scheduling process 258, if the workload is accepted as specified by acceptance/rejection 256, then the workload may be scheduled for performance. Otherwise, the request is rejected, and the workload is not scheduled for performance.

To perform workload scheduling process 258, characteristics of the requested workload may be identified (e.g., as discussed with regard to workload requirements 255). For example, performance of the workload may require no more than an hour to complete successfully. The queue may be checked for a range of time that is equal to or greater than the no more than an hour. If the queue has the range available between other workloads scheduled in the queue, the requested workload may be scheduled in a first range available. If the queue does not have the range available, then the requested workload may be scheduled at the end of the queue,

Thus, using the data flows shown in FIGS. 2E-2F, power may be managed to enhance performance of workloads.

Turning to FIG. 2G, a third data flow diagram in accordance with an embodiment is shown. The third data flow diagram may illustrate data used in and data processing performed in identifying workload requirements (e.g., parameters for an operating state of a data processing system (and/or components thereof) in which a workload associated with the workload requirements may be performed and completed successfully.

To identify the workload requirements, power estimation process 262 may be performed. During power estimation process 262, (i) workload request 260 may be obtained, (ii) characteristics of the workload may be obtained, (iii) the characteristics of the workload may be used to estimate the power consumption for performance of the workload, (iv) the power consumption estimates may be stored at workload requirements 255, and/or (v) other operations may be performed.

Workload request 260 may be obtained by receiving the request from a requestor. Workload request 260 may indicate a workload to be performed.

To obtain the characteristics of the workload, information regarding an inference model that will be used in the workload may be obtained. The information may include, for example, (i) a type of the inference model, (ii) a phase of a life cycle of the inference model, (iii) a size of the inference model, (iv) a quantity of data to be used during the workload, and/or (v) other types of information regarding the inference model. The size of the inference model may be based on parameters of the inference model. The quantity of data to be used may be training data, update data, and/or input data.

To estimate the power consumption for performance of the workload using the characteristics of the workload, power estimation data 264 may be used. Power estimation data 264 may include data (e.g., power estimation data) that associates different characteristics of the workload with different levels of power consumption. For example, a type of the inference model may be used to identify an associated first level of power consumption.

Therefore, a different level of power consumption may be identified using power estimation data 264 for each of the characteristics of the workload. These different levels of power consumption may, for example, each be recorded in a single data structure such as workload requirements 255.

Once obtained, workload requirements 255 may be stored in storage available to a power manager responsible for managing the workload. For example, a power manager may use workload requirements 255 to assign the workload to a data processing system best suited to perform, during a window of time best suited to successfully complete, the workload. For additional information regarding assignment and/or scheduling of the workload, refer to FIG. 2H below.

Turning to FIG. 2H, a fourth data flow diagram in accordance with an embodiment is shown. The fourth data flow diagram may illustrate data used in and data processing performed in obtaining a workload placement decision indicative of a window of time (mentioned previously with regard to FIG. 2G) of a data processing system to facilitate performance and successful completion of the workload.

To obtain the workload placement decision, scheduling process 266 may be performed. During scheduling process 266, (i) workload requirements 255 may be obtained, (ii) available power repository 268 may be used to identify one or more windows of time during which workload requirements 255 are met by data processing systems that have sufficient power to perform the requested workload (the workload that has yet to be accepted), (iii) the one or more windows of time may be used to identify data processing systems that have the one or more available time windows in which to complete the workload, (iv) the data processing systems having available time windows may be narrowed down, using placement criteria, to identify a single data processing system, (iv) workload placement decision 270 may be generated, and may include information identifying the single data processing system and/or window of time associated with the data processing system, (v) the workload may be assigned to the identified data processing system based on workload placement decision 270, and/or (vi) other operations may be performed.

To identify the one or more windows of time during which sufficient power (e.g., available power that meets the workload requirements) is available to perform the requested workload, for each available data processing system that may host the workload: (i) future power availability of a data processing system may be identified using available power repository 268, (ii) identification regarding whether power requirements specified by workload requirements 255 can be satisfied by the data processing system at any point in time using the future power availability may be made, (iii) data processing systems that can satisfy the power requirements may be added to a list of data processing systems along with window information for the period of time when the data processing system has sufficient power availability to satisfy the power requirements, and/or other operations may be performed to identify the one or more time windows.

Available power repository 268 may be a data structure that specifies the future power availability of data processing systems that may perform the workload. Available power repository 268 may be populated by analyzing the accepted workloads by each of the data processing systems as well as the power available to the data processing systems. For example, the future power availability for a data processing system may be identified by, for each accepted workload, estimating power that will be consumed for performing the accepted workload. This power estimate may be subtracted from the power available to the data processing system to identify the remaining amount of power that will be available to the data processing system while the workload is being performed. This process may be repeated for all of the accepted workloads to establish the future power availability of the data processing system.

For example, if a data processing system has accepted a first workload that is estimated to consume 250 watts of power from 12:00-12:15 and a second workload that is estimated to consume 100 watts of power from 12:20-12:25 and the data processing system has a total available power of 1000 watts, then the future power availability of the data processing system may be 750 watts from 12:00-12:15, 1000 watts from 12:15-12:20, 900 watts from 12:20-12:25, and 1000 watts from 12:25-12:30.

The aforementioned process may be repeated for all of the data processing systems thereby allowing for any number of future power availability to be identified.

Therefore, to identify data processing systems that have, at least in part, the one or more windows of time in which to complete the workload, the list of data processing systems (mentioned above) may be checked. For example, each data processing system may be associated with window information for the period of time when each respective data processing system has sufficient power availability to satisfy the power requirements. These associations may be used to correctly identify the data processing systems.

To narrow down data processing systems, placement criteria may be used to identify a single data processing system. The placement criteria may define a set of rules used to determine which data processing system from the list of data processing systems has a lowest likelihood (e.g., when compared to the other data processing systems from the list) of compromise to itself and/or any of its accepted workloads should the requested workload be accepted. To do so, the defined set of rules may specify a hierarchy of importance with regard to characteristics of the data processing systems and/or the associated windows of time. For example, placement criteria may specify that a time at which an associated window begins is of the highest importance, compared to a quantity of time exceeding the required amount of time to complete the workload by.

For example, a workload may require at least 5 minutes to be completed. Assume the list of data processing systems includes a first data processing system. The first data processing system may have a first window from 1:00-1:20, a second window from 2:10-4:50, and a third window from 5:00-5:15. Despite the second window exceeding the required 5 minutes more than the other windows (e.g., by 2 hours and 40 minutes), the first window may be determined as the most desirable window (out of the three windows) based on the placement criteria. However, if the list further included a second data processing system with a fourth window from 1:00-1:25, the fourth window may be determined as the most desirable window due to (i) beginning at a same time as the first window, and (ii) exceeding the required 5 minutes by a quantity of time larger than what is exceeded by the first window.

To generate workload placement decision 270, information regarding the single data processing system and an associated and most desirable window (when compared to the other windows) may be stored in storage available to, for example, the power manager.

Therefore, the list of data processing systems may be narrowed to obtain the single data processing system along with a single associated window of time. This single data processing system, along with any relevant information (i) regarding the single data processing system and/or (ii) for performing the workload (e.g., the single associated window of time) different levels of power consumption may, for example, each be recorded in a single data structure such as workload placement decision 270.

Once obtained, workload placement decision 270 may be stored in storage available to a power manager responsible for managing the requested workload. For example, a power manager may use workload placement decision 270 to assign the workload to the single data processing system best suited to perform, and during a window of time best suited to successfully complete, the workload.

To assign the workload to the identified data processing system based on workload placement decision 270, the power manager, for example, may forward workload placement decision 270 (along with any of the relevant information) to the identified data processing system.

As discussed above, the rail mounted power systems may have a finite amount of power that can be provided, and if demand for power exceeds this finite amount of power, then the rail mounted power systems may exhibit unpredictable behavior. For example, the rail mounted power systems may fail to provide power that is conditioned as expected by the chassis. For example, the voltage and/or current levels may not meet the requirements of the consumers of the power. Consequently, the consumers of the power may be negatively impacted (e.g., brownouts may occur, components may reset, etc.).

To reduce the likelihood of the rail mounted power systems exhibiting the unpredictable behavior, chassis may be selectively throttled to keep the demand for power within that which can be supplied by the rail mounted power systems. The chassis may be selectively throttled in a manner that reduces lost work due to the throttling. FIGS. 2I-2K show data flow diagrams illustrating processes that may be used to reduce the likelihood of the rial mounted power systems exhibiting the unpredictable behavior.

Turning to FIG. 2I, a fifth data flow diagram in accordance with an embodiment is shown. The fifth data flow diagram may illustrate data used in, and data processing performed in, monitoring power for occurrences of overdrawn power (e.g., power pulled from a power source exceeding a power provision capacity (e.g., limit) of the power source.)

To monitor the power, power distribution unit (PDU) monitoring process 276 may be performed to obtain overdraw determination 278. To perform PDU monitoring process 276, a total power demanded from the PDU may be identified during any given instantaneous moment (to be referred to as an aggregate power draw of an instantaneous power demand). Based on this aggregate power draw, a determination may be made regarding whether the aggregate power draw exceeds the power provision capacity. Consequently, exceeding this power provision capacity may have unpredictable consequences on the data processing system. However, while maintaining a range under the limit, a likelihood of predictable outcomes may increase for the data processing system.

By obtaining overdraw determination 278, further steps may be taken to decrease a likelihood of compromise from unpredictable outcomes cause by overdrawn power.

During PDU monitoring process 276, (i) PDU output capacity 272 may be identified (e.g., the power provision capacity), (ii) collective power supply unit (PSU) power usage 274 (e.g., the aggregate power draw) may be obtained, (iii) based on PDU output capacity 272 and collective PSU power usage 274, a comparison may be made to determination whether PDU output capacity 272 has been exceeded by collective PSU power usage, (iv) based on the comparison, obtaining overdraw determination 278 that indicates whether PDU output capacity 272 has been exceeded, and/or (v) other processes may be performed.

To identify PDU output capacity 272, for example, a repository (e.g., a log) of data regarding characteristics of the power components may be accessed. For example, a device manager may access and/or otherwise facilitate electrical transmissions with a PSU of the power supplies, and/or the PDU, similar to the discussion of FIG. 2F. In doing so, information regarding the PDU such as the power provision capacity, minimum power capacity, etc. may be obtained. Additionally, for example, a rate of power consumption may be logged in long term storage throughout a utilization of the PDU and/or PSU. In doing so, PSU power usage 274 may be obtained for an instantaneous power demand and/or used for various processes in the future (after the instantaneous power demand.)

Therefore, if PDU output capacity 272 is 500 W and collective PSU power usage 274 is 300 W, for example, the power provision capacity has not been exceeded. However, if collective PSU power usage 274 is instead 550 W, the power provision capacity has been exceeded and further processes may be performed to decrease a likelihood of compromise caused by unpredictable outcomes of the data processing system. For example, the power manager may perform a method for throttling devices such as external power supply of the rail mounted power system, discussed below with respect to FIG. 2J.

Turning to FIG. 2J, a sixth data flow diagram in accordance with an embodiment is shown. The sixth data flow diagram may illustrate data used in, and data processing performed in, throttling power consumption of external power supply based on established priorities. For example, throttling may be performed based on an occurrence of overdrawn power to decrease a likelihood of compromise, discussed previously with regard to FIG. 2I.

To throttle the external power supply (e.g., the PSU of the power supplies discussed above), throttling prioritization process 284 may be performed to obtain throttle instruction 286. To perform throttling prioritization process 284 based on the established priorities, priorities (e.g., a data structure that includes associates between various chassis and respective scores based on a scoring system) may first be ranked for each power supply free chassis to obtain, for example, priority rankings 280. For additional information regarding how the priorities may be established to obtain priority rankings 280, refer to FIG. 2K.

Based on the established priorities, a list of available chassis (e.g., a number of power supply free chassis) may be used to generate a hierarchal list of the available chassis, a position in the hierarchy indicating a cost on computing resources (e.g., duration of time, available storage, processing capacity and/or computation cost, etc.) to reperform workloads assigned to a respective chassis in the position. For example, a first chassis positioned at a top of the hierarchy may consume a large quantity of computing resources compared to a second chassis positioned anywhere else in the hierarchy, and therefore, would not be desirable to reperform respective workloads of the first chassis.

Using the hierarchy, throttling prioritization process 284 may be performed to determine a least costly (with respect to the computing resources) course of action to decrease a likelihood of compromise from unpredictable outcomes cause by overdrawn power.

Therefore, during throttling prioritization process 284, for example, (i) roster for responsive throttling 282 (e.g., the list of available chassis) may be obtained, (ii) priority ranking 280 (e.g., the established priorities) may be obtained, (iii) the available chassis included in roster for responsive throttling 282 may be ordered based on point values for each chassis using priority ranking 280 to obtain a rank ordering indicative of the hierarchy, (iv) identifying, based on the rank ordering, a lowest ranked one of the chassis, (v) obtaining, based on the lowest ranked one of the chassis, throttle instruction 286, and/or (vi) other processes may be performed.

Throttle instruction 286 may be, for example, an action set performed to throttle power to a chassis, thereby alleviating the instantaneous power demand on the PDU that caused an occurrence of overdrawn power.

It will be appreciated that the occurrence of overdrawn power may be an occurrence of a prediction indicating a high likelihood of overdrawing power, and therefore, may initiate the aforementioned processes as a proactive prevention of unpredictable outcomes caused by overdrawn power rather than a reactive prevention in an attempt to limit and/or prevent the unpredictable outcomes.

The action set may include, for example, executing computer code on which throttling operations of a data processing system depend. By identifying and using the lowest rank one of the chassis to obtain throttle instruction 286, throttling of the lowest ranked one of the chassis may be performed. Thus, less power may be drawn from the PDU with a mitigated loss of computing resources, thereby decreasing the likelihood of unpredictable outcomes caused by overdrawn power.

As previously discussed, priorities may be ranked for each power supply free chassis to establish the priorities (e.g., priority rankings 280). This establishment of the priorities is discussed in FIG. 2K below.

Turning to FIG. 2K, a seventh data flow diagram in accordance with an embodiment is shown. The seventh data flow diagram may illustrate data used in, and data processing performed in, establishing priorities based on a phase of a lifecycle of an inference model that must be used to perform a workload.

For example, to obtain priority rankings 280 in FIG. 2J, relation prioritization process 290 may be performed. In doing so, associations between various chassis and respective scores that are based on a scoring system may be established.

During relational prioritization process 290, (i) workload characteristics 288 (e.g., a list of workloads with associated characteristics of the workloads) may be obtained for each chassis dependent on power provided by the PDU, (ii) scoring system 289 may be obtained to define a set of rules for quantifying computational costs associated with workload characteristics 288, (iii) a respective point value may be assigned to each of the chassis based on workload characteristics 288 and scoring system 289, thereby assigning a respective rank (that is based on and/or indicative of the point values) to each of the chassis, (iv) the associations between each of the chassis and respective ranks may be recorded in a log to obtain, for example, priority rankings 280, and/or (v) other processes may be performed.

Workload characteristics 288 may include information regarding (i) workloads being performed by a power supply free chassis dependent on power provided by the PDU, (ii) types of the workloads, (iii) lifecycle phases of the workloads of at least one of the types of the workloads, and/or (iv) other characteristics of the workloads not to be limited by embodiments discussed herein.

It will be appreciated that workload characteristics 288 may include information, as discussed above, for all of the chassis' dependent on power provided by the PDU, a portion of all of the chassis, and/or a single chassis. Furthermore, the proceeding processes, mentioned above, may be performed until respective ranks are obtained for all of the chassis (e.g., there may be more than one iteration of obtaining workload characteristics 288).

The types of the workloads, as mentioned above, may include the at least one of the types (further referred to as “the at least one type” and/or “a first type”). For example, this first type of workload may be an artificial intelligence workload type. Therefore, the lifecycle phases of the workloads of the first type may be one of an enumerated number of phases of artificial intelligence workloads.

These enumerated number of phases may include, at least, (i) a training phase, (ii) an inferencing phase, and (iii) an updating phase. For example, the training phase may be a first portion of time during which an inference model (e.g., a machine learning algorithm) is trained for a purpose; the inferencing phase may be a second portion of time during which the inference model generates inferences for the purpose; and the updating phase may be a third portion of time during which the inference model is retrained (e.g., updated, modified, etc.) to modify how inferences may be further generated for the purpose.

Scoring system 289, as previously mentioned, may specify a set of rules for scoring chassis based on workloads scheduled to be performed and/or that are being performed. This set of rules may be referenced (and/or otherwise used) to quantify an importance of workload loss prevention with respect to respective workloads. Additionally, due to a capacity of some chassis to perform one or more workloads concurrently, and/or schedule subsequent and/or concurrent performance of one or more workloads, the set of rules may be used to quantify an importance of continuous operation with respect to respective chassis.

This set of rules may be based, at least in part, on associations between different types of the lifecycle phases and different point values. Furthermore, the point values may be based on computation costs (noted previously with regard to FIG. 2J) for reperforming workloads in the different types of the lifecycle phases. For example, inferencing may be performed quickly and may output similar results consistently (e.g., assuming a well-trained inference model) and therefore, may have a lowest computational cost compared to the other types of the lifecycle phases. Training of the inference model may require processing of a large quantity of training data, and therefore, may have a highest computational cost compared to the other types of the lifecycle phases. Updating the inference model may have a computational cost higher than that of the inferencing, but lower than that of the training. Thus, for example, a three-point system (for simplicity) may be used to assign point values to the lifecycle phases; giving the training phase a 1, the updating phase a 2, and the inferencing phase a 3. An example application of this three point system is discussed further below.

By using a scoring system such as the three point system, computational costs associated with performance and/or reperformance of a workload may be identified prior to the performance and/or the reperformance of the workload.

For example, reperformance of a workload may occur should performance of the workload be interrupted. Performance of a workload may be interrupted, for example, as part of an unpredictable outcome caused by overdrawn power. Therefore, in an attempt to prevent unpredictable outcomes such as workload loss from the interruption, some chassis of a lower priority may have their power consumption reduced. In doing so, chassis of a higher priority may have a decreased likelihood of workload loss. This prioritization of chassis may be based on the scoring system, the higher prioritization indicating a higher computational cost associated with reperformance of workloads lost by that chassis when compared to the lower prioritized chassis. Thus, the scoring system may be used to mitigate an impact on the rack system, and/or prevent overdrawn power entirely by placing a higher priority on particular chassis, and allowing power consumed by the chassis of a lower priority to be throttled.

For example, assume a scenario in which a rack system includes a rail mounted power system and three chassis. The three chassis may be power supply free chassis and may rely on a PDU of the rail mounted rack system to distribute power to various power supplies that are operably connected to a combination of at least one of the three chassis, and on which operation of the three chassis depend. Additionally, these operable connections may facilitate redundancy of power (previously discussed) for the three chassis. The redundancy of power may be facilitated as specified by a power connectivity map, mentioned with regard to FIG. 2B. For example, further assume at least a portion of the power supplies is operably connected to provide redundant power to one of the three chassis and assume this is true for each of the power supplies operably connected to provide power.

A first chassis of the three chassis may be performing a single workload that is in a training phase, thereby causing (e.g., by identifying) an association between a point value of 1 and the first chassis. A second chassis of the three chassis may be performing a second singular workload that is in an inferencing phase, thereby causing an association between a point value of 3 and the second chassis. Finally, a third chassis of the three chassis may be performing a third singular workload that is in an updating phase, thereby causing an association between a point value of 2 and the third chassis.

Thus, priority rankings 280 may include associations that link each of the three chassis to the point values such that (i) the first chassis is linked to the point value 1, (ii) the second chassis is linked to the point value 3, and (iii) the third chassis is linked to the point value 2.

By establishing these priorities based on the scoring system, priority rankings 280, for example, may be used in such processes as discussed with respect to FIG. 2J.

For additional information regarding the establishment of the priorities, and/or for additional examples used to portray (compared to the three-point system, discussed above) a more complex scenario dependent on the scoring system, refer to FIG. 3C further below.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, using the data flows shown in FIGS. 2E-2K, performance of workloads by hardware components housed in power supply free chassis of a rack system may be managed to decrease a likelihood of compromise of data processing systems and/or associated workloads.

As discussed above, the components of FIGS. 1-2K may perform various methods to manage performance of workloads by data processing systems. FIG. 3A-3C illustrate methods that may be performed by the components of FIGS. 1-2K.

In the diagrams discussed below and shown in FIGS. 3A-3C, any operations may be repeated, performed in different orders, and/or performed in parallel with, or partially overlapping in time with, other operations.

Turning to FIG. 3A, a first flow diagram illustrating a first method for managing performance of workloads by hardware components (housed in a power supply free chassis of a rack system) in accordance with an embodiment is shown.

The first method may be performed by, for example, a power manager, rail mounted power system (integrated with a single vertical rail of the rack system), and/or any other entity.

It will be appreciated that although described with regard to being integrated with a single vertical rail of the rack system, the rail mounted power system may be capable of integrating with any single vertical rail of the rack system.

At operation 300, a request is obtained to perform a workload. The request may be obtained by hardware resources (e.g., the hardware components) of the data processing system communicating with other devices operably connected to the data processing system (e.g., via communication channels). For example, a user of the data processing system may initiate an action set to provide a functionality of a device operably connected to the data processing system (e.g., using a mouse and keyboard). By initiating the action set, a request for performing the workload associated with the functionality may be provided to a processor of the data processing system.

The action set may depend on a level of power consumption necessary and may include, for example, executable computer code on which the action set is based.

Thus, this communication may facilitate a traversal of data indicative of the action set to be performed, the action set being dependent on a level of power consumption necessary for performing the action set to perform the workload.

At operation 302, power risk assessments are obtained for rail mounted power systems of a rack system based on the request. The power risk assessments may be obtained by (i) obtaining health information for the rail mounted power system, and (ii) obtaining a power connectivity map that indicates, at least, dependence of the power supply free chassis of the rack system on the rail mounted power system for power, and (iii) using the health information and the power connectivity map with a risk assessment system, to obtain a power risk assessment.

The health information for the rail mounted power system may be obtained by accessing, for example, a repository (e.g., a log) of data regarding characteristics of the power components. For example, a device manager may access and/or otherwise facilitate electrical transmissions with a power supply unit of the power supplies to obtain information regarding the power supply unit such as maximum power capacity, minimum power capacity, etc. Additionally, for example, a rate of power consumption may be logged in long term storage throughout a utilization of the power supply unit.

The power connectivity map, as noted above, may indicate dependence of the power supply free chassis on the rail mounted power system of the rack system for power. For example, the power connectivity map may indicate that specific hardware components of the power supply free chassis are dependent on consumption of specific power supply level power from, in some cases, specific power components.

The risk assessment system may include acceptable risk criteria to be implemented with a rule set defining how the health information and/or the power connectivity map may be accessed, read, interpreted, modified, and/or otherwise used. Thus, the health information and the power connectivity map may be obtained with the risk assessment system.

At operation 304, a power consumption estimate is obtained for the workload based on the request. The power consumption estimate may be obtained by identifying subprocesses required to complete the workload. For example, a workload may include 10 instances of multiplication processes, 5 instances of division processes, and 25 instances of a look up process using a database. Events regarding these subprocesses may already have logs defining levels of power used (e.g., and/or how long a level of power was used), and those logs may be used to determine a power consumption estimate for any and/or all the power supplies available.

At operation 306, a determination is made regarding whether the request is accepted based on the power risk assessments and acceptable risk criteria. The determination may be made by comparing the power risk assessments with each of the rules defined by the acceptable risk criteria, previously mentioned.

For example, the acceptable risk criteria may indicate a requirement for 65 watts for a duration of at least 3 hours to perform the workload. Therefore, if the power risk assessment for the power supply unit provides less than 65 watts at any given time, and/or may not be expected to be able to provide 65 watts or more for more than 3 hours, the request may not be accepted.

If determined that the request is accepted, then the first method may proceed to operation 308. Otherwise, the first method may proceed to operation 310.

At operation 308, the workload is performed using at least a portion of the hardware components. The workload may be performed by executing the executable computer code on which the action set depends. For example, the executable computer code may be processed by a processor of the power supply free chassis, thereby causing at least a portion of the hardware components to facilitate the action set to perform the workload. The first method may end following operation 308.

Returning to operation 306, the first method may proceed to operation 310.

At operation 310, the request is rejected. The request may be rejected by not providing the executable computer code to the processor and/or otherwise preventing the action set, and thus, preventing performance of the workload.

It will be appreciated that although mentioned with regard to preventing performance of a workload, rejecting the request may include, for example, modifying a workload schedule (e.g., queue) for any of the hardware components and/or any of the power supplies.

The first method may end following operation 310.

Thus, externally placed power components for providing power to the power supply free chassis may be managed to, for example, optimize performance of workloads facilitated by hardware components dependent on the externally placed power components.

For example, by depending on the acceptable risk criteria to allow for management of workloads, the management may be based on characteristics of the workloads and characteristics of the power components. Therefore, a likelihood of damage caused by a lack of power available and/or caused by an excess of power directed for performing the workload may be decreased.

Additionally, by using the first method above, externally placed power components may be managed while providing a means for placement of additional hardware components within an interior of the power supply free chassis made usable by an absence of power component in the interior of the power supply free chassis.

Therefore, a type, quantity and/or quality of computer implemented services to be provided may be increased while decreasing a likelihood of compromise of the hardware components caused by the power directed to the power supply free chassis (e.g., a loss of power during performance of workloads).

As discussed above, a data processing system may obtain (e.g., receive from a device) a request to perform a workload. Using the first method discussed above and throughout FIG. 3A, the data processing system may reject or accept the request. Acceptance of the request may initiate performance of the workload and rejection of the request may prevent the performance of the workload entirely. However, before the request is received by the data processing system, for example, a power manager may perform a second method as discussed below with respect to FIG. 3B.

Thus, as previously mentioned, the components of FIGS. 1-2K may perform, at least in part, various methods to manage performance of workloads by data processing systems. FIG. 3B illustrates a second method that may be performed by the components of FIGS. 1-2K.

Turning to FIG. 3B, a second flow diagram illustrating the second method for managing performance of workloads by hardware components (housed in a power supply free chassis of a rack system) in accordance with an embodiment is shown. The method may be performed by, for example, a power manager and/or any other entity.

At operation 312, a request is obtained to perform a workload (e.g., the workload discussed with regard to FIG. 3A). The request may be obtained by (i) reading the request from storage, (ii) receiving the request from another device (e.g., via a message), (iii) generating the request, and/or via other methods. For example, the request may be obtained by receiving the request via message. A power manager operably connected to (and/or otherwise in communication with) a data processing system capable of performing workloads may receive the message. These data processing systems may include, for example, the data processing system discussed with regard to FIG. 3A.

It will be appreciated that operation 312 may be performed in a similar manner as that described with regard to operation 300 in FIG. 3A, by hardware resources of the data processing system (e.g., the power manager) communicating with other devices operably connected to the data processing system (e.g., via communication channels). For example, a user of the data processing system may initiate an action set to provide a functionality of a device operably connected to the data processing system (e.g., using a mouse and keyboard). By initiating the action set, a request for performing the workload associated with the functionality may be provided to a processor such as the power manager of the data processing system.

At operation 314, workload requirements are obtained based on the request for the workload based, at least in part, on a phase of a lifecycle of an inference model that must be used to perform the workload. The workload requirements may be obtained by (i) reading the workload requirements from storage, (ii) receiving the workload requirements from another device (e.g., via a message), (iii) generating the workload requirements, and/or via other methods. For example, the workload requirements may be obtained by performing a power estimation process as discussed with regard to FIG. 2G.

For example, to generate the workload requirements, (i) a workload request may be obtained, (ii) characteristics of the workload may be obtained based on the request, (iii) a quantity of power consumed to perform the workload may be estimated based on the characteristics, (iv) this quantity may be stored and later used as the workload requirements, and/or other operations may be performed to generate the workload requirements.

For additional information regarding the workload requirements and how they may be obtained, refer to FIG. 2G.

At operation 316, a scheduling process is performed using the workload requirements and information regarding power available to data processing systems of the power supply free chassis to identify a data processing system of the data processing systems to perform the workload. The schedule process may be performed by (i) identifying, using the workload requirements and an available power repository in which the information regarding where the power available to the data processing systems is stored, at least one data processing system of the data processing systems for which a minimum window of available power that meets the workload requirements is associated; and (ii) identifying, based on placement criteria, the data processing system of the at least one data processing system.

The at least one data processing system may be identified by (i) identifying future power availability of a data processing system using the available power repository, (ii) identifying whether power requirements specified by the workload requirements can be satisfied by the data processing system at any point in time using the future power availability, and (iii) if the power requirements can be satisfied by the data processing system, then the data processing system may be added to a list of data processing systems along with window information for the period of time when the data processing system has sufficient power availability to satisfy the power requirements. For example, the data processing system may have workloads queued for performance, each workload being scheduled for performance during a window of time different from one another. If a requested workload has a workload requirement such as needing an hour to perform the requested workload to completion, then a data processing system may be identified that has a window of time of at least an hour within a respective queue. By obtaining the list, the one or more data processing system may be obtained.

The data processing system may be identified by using placement criteria, specifying a hierarchy of importance with regard to characteristics of the one or more windows of time, to discriminate a data processing system from the list mentioned above. For example, the placement criteria may specify an earliest window of time as having highest importance. Therefore, whatever data processing system from the list that has a soonest window of time available (compared to a rest of the one or more windows of time of other data processing systems from the list) may be identified.

At operation 318, the workload request is forwarded to a power manager of the data processing system to attempt to complete performance of the workload to provide desired computer implemented services. The workload request may be forwarded by (i) reading the workload placement decision from storage, (ii) assigning the workload to the single data processing system based on the workload placement decision, (iii) using communication channels to provide (e.g., forward) the workload request to the single data processing system, and/or via other methods.

The second method may end following operation 310.

For additional information regarding the workload placement decision, refer to FIG. 2H.

As discussed throughout embodiments herein, a data processing system may obtain (e.g., receive from externally positioned power supplies) power to perform a workload (and/or one or more workloads). However, if parameters of devices used to provide power are not maintained, operation of the data processing system may become unpredictable, thereby increasing a likelihood of compromise of the data processing system.

To power the data processing system while decreasing a likelihood of compromise, a power manager (e.g., a same power manager as discussed previously and/or a different power manager) may monitor the power. In doing so, power parameters of the power distribution unit (previously discussed) may be maintained to increase a likelihood of predictable operation of the power distribution unit (PDU). For example, the power manager may perform a third method as discussed below with respect to FIG. 3C.

As stated previously, the components of FIGS. 1-2K may perform, at least in part, various methods to manage performance of workloads by data processing systems. FIG. 3C illustrates a third method that may be performed by the components of FIGS. 1-2K.

Turning to FIG. 3C, a third flow diagram illustrating the third method for managing performance of workloads by hardware components (housed in a power supply free chassis of a rack system) in accordance with an embodiment is shown. The method may be performed by, for example, a power manager and/or any other entity.

At operation 320, an aggregate power draw of power supplies of a rail mounted power system is obtained. The aggregate power draw may be obtained by (i) identifying all chassis that depend on power provided by a power distribution unit (PDU) of the rail mounted power system to operate (e.g., using the power connectivity map, discussed with respect to FIG. 2B), (ii) identifying a respective, individual power draw per chassis occurring within a same instant (e.g., an instantaneous power draw or power demand for each chassis dependent on the PDU), (iii) obtaining, using the instantaneous power draw (or power demand) for each chassis dependent on the PDU, a sum of collective power drawn instantaneously by all of the chassis, the sum defining the aggregate power draw, and/or (iv) performing other processes for obtaining the aggregate power draw of the power supplies.

At operation 322, a maximum power output of a power distribution unit (PDU) of the rail mounted power system is identified. The maximum power output for the PDU may be obtained by (i) reading the maximum power output from storage, (ii) receiving the maximum power output from another device, (iii) inferring the maximum power output based on other data, and/or via other methods.

At operation 324, a determination is made, based on the maximum power output and the aggregate power draw, regarding whether the aggregate power draw exceeds the maximum power output. The determination may be made by making a comparison between the aggregate power draw and the maximum power output. For example, the comparison may include checking whether the aggregate power draw is a higher wattage or a lower wattage than the maximum power output.

If determined that the aggregate power draw exceeds the maximum power output, then the third method may proceed to operation 326. Otherwise, the third method may proceed to operation 332.

At operation 326, each chassis that draws power from any of the power supplies is ranked, with regard to one another and based on priority rankings, to obtain a rank ordering of the chassis. Each chassis may be ranked by (i) obtaining a list (e.g., a roster) specifying chassis available for throttling (e.g., all chassis that depend on power provided by a PDU of the rail mounted power system) to operate, (ii) obtaining priority rankings that define associations between respective chassis and point values, (iii) obtaining a rank ordering in which the chassis listed in the roster are ordered based on sequential relationships between one another (e.g., listed from a first chassis associated with a lowest point value to a second (or third, fourth, fifth, etc.) chassis associated with a highest point value), and/or (iv) performing other processes to obtain the priority ranking.

The list of available chassis may be obtained, for example, based on a power connectivity map, discussed with regard to FIG. 2B.

The priority rankings may be established as discussed with regard to FIG. 2K. For example, a priority ranking of the priority rankings may be based on, at least, (i) workloads being performed by the power supply free chassis, (ii) types of the workloads, (iii) lifecycle phases of the workloads of at least one of the types of the workloads, and/or (iv) a scoring system usable to quantify a cost for reperforming the workloads.

To quantify this cost for reperforming the workloads, the scoring system may include associations between different types of the lifecycle phases and different numbers of point values, the point values being based on computation costs for performing workloads in the different types of the lifecycle phases. For example, the at least one of the types of the workloads is an artificial intelligence workload type. Therefore, the lifecycle phases may be one of an enumerated number of phases of artificial intelligence workloads such as (i) a training phase, (ii) an inferencing phase, and/or (iii) an updating phase. Based on these lifecycle phases, the workloads may be associated with point values used to obtain the rank ordering specifying a lowest ranked one of the chassis listed sequentially with other chassis, the order ending at a highest ranked one of the chassis.

At operation 328, a lowest ranked one of the chassis is identified based on the rank ordering. The lowest ranked one of the chassis may be identified by (i) performing a lookup to identify a lowest position on the rank ordering, (ii) checking which chassis is associated with that lowest position to obtain the lowest ranked one of the chassis, and/or (iii) other processes may be performed.

At operation 330, the lowest ranked one of the chassis is throttled to prevent the maximum power output from being exceeded to provide computer implemented services using a portion of the chassis. The lowest ranked one of the chassis may be throttled by limiting power provided to the lowest ranked chassis, thereby limiting an overall power demand on the PDU to decrease a likelihood of unpredictable outcomes caused by overdrawn power.

To limit the power demand on the PDU, instructions may be sent to a power manager of the lowest ranked one of the chassis. The instructions may set a limit on power consumption for the host system. The power manager may identify one or more hardware components of the host system, and issue corresponding instructions to the hardware components to limit power consumption by the one or more hardware components. For example, the instructions may be to reduce clock rates, disable operation of some portions of the hardware components, etc. Thus, the reduced power consumption by these hardware components may reduce the power consumption by the host system to be within desired limits.

The third method may end following operation 330.

Returning to operation 324, the third method may proceed to operation 332.

At operation 332, the computer implemented services are provided using all of the chassis. The computer implemented services may be provided by providing power (e.g., from the PDU) on which operation of all of the chassis depend to perform workloads that when completed cause the computer implemented services to be provided.

Thus, externally placed power components for providing power to the power supply free chassis may be managed using, for example, the third method, second method and/or the first method to optimize performance of workloads facilitated by hardware components dependent on the externally placed power components.

For example, by depending on an available power repository to allow for management of workloads (e.g., generating a workload placement decision while considering a quantity of power necessary to perform the workload), the management may be based on characteristics of the workloads and characteristics of the power components. Therefore, a likelihood of damage caused by a lack of power available and/or caused by an excess of power directed for performing the workload (e.g., “overdrawn power”) may be decreased.

Additionally, by using a rail mounted power system, externally placed power components may be managed while providing a means for placement of additional hardware components within an interior of the power supply free chassis made usable by an absence of power component in the interior of the power supply free chassis.

Therefore, by increasing a type, quantity and/or quality of computer implemented services to be provided a likelihood of compromise of the hardware components caused by the power directed to the power supply free chassis (e.g., a loss of power during performance of workloads).

Any of the components illustrated in and/or discussed with regard to FIGS. 1-2K may be implemented with and/or used in conjunction with one or more computing devices. For example, the security bezel may be used to secure a chassis in which components of a data processing system may be positioned (e.g., processors, memory, etc.). Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components as such details are not germane to embodiments disclosed herein. It will also be appreciated that network computers, handheld computers, mobile phones, servers, and/or other data processing systems which have fewer components, or more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing performance of workloads by hardware components housed in power supply free chassis of a rack system, the method comprising:
obtaining an aggregate power draw of power supplies of a rail mounted power system;
identifying a maximum power output of a power distribution unit of the rail mounted power system; and
making a determination, based on the maximum power output and the aggregate power draw, regarding whether the aggregate power draw exceeds the maximum power output; and
in a first instance of the determination where the maximum power output is exceeded:
ranking, with regard to one another and based on priority rankings, each of the power supply free chassis that draws power from any of the power supplies to obtain a rank ordering of the chassis;
identifying, based on the rank ordering, a lowest ranked one of the chassis; and
throttling the lowest ranked one of the chassis to prevent the maximum power output from being exceeded to provide computer implemented services using a portion of the chassis; and
in a second instance of the determination where the maximum power output is not exceeded:
providing the computer implemented services using all of the chassis.

2. The method of claim 1, wherein the aggregate power draw is an instantaneous power demand on the power distribution unit from the power supplies.

3. The method of claim 1, wherein a priority ranking of the priority rankings is based on, at least:
workloads being performed by the power supply free chassis;
types of the workloads;
lifecycle phases of the workloads of at least one of the types of the workloads; and
a scoring system usable to quantify a cost for reperforming the workloads.

4. The method of claim 3, wherein the scoring system comprises associations between different types of the lifecycle phases and different numbers of point values.

5. The method of claim 4, wherein the point values are based on computation costs for performing workloads in the different types of the lifecycle phases.

6. The method of claim 3, wherein the at least one of the types of the workloads is an artificial intelligence workload type.

7. The method of claim 6, wherein the lifecycle phases are one of an enumerated number of phases of artificial intelligence workloads.

8. The method of claim 7, wherein the enumerated number of phases comprises:
a training phase;
an inferencing phase; and
an updating phase.

9. The method of claim 8, wherein ranking each chassis comprises:
obtaining a roster of available chassis;
obtaining priority ranking; and
ordering the chassis based on point values for each chassis using the priority ranking to obtain the rank ordering.

10. The method of claim 1, wherein the rack system is adapted for placement of the power supply free chassis in a high-density computing environment comprising data processing systems, the rack system comprising:
a rack for housing at least a portion of the data processing systems and adapted to hold at least one power supply free chassis, and the rack comprising at least one vertical rail; and
a rail mounted power system adapted to mount directly to a single vertical rail of the at least one vertical rail.

11. The method of claim 10, wherein the rail mounted power system comprises:
a power distribution unit adapted to obtain rack system level power and distribute, using the rack system level power, power supply level power; and
at least one power supply adapted to obtain a portion of the power supply level power and distribute, using the power supply level power, logic level power to the at least one of the chassis.

12. A non-transitory machine-readable medium having instructions stored therein, which when executed by a processor, cause the processor to perform operations for managing performance of workloads by hardware components housed in power supply free chassis of a rack system, the operations comprising:
obtaining an aggregate power draw of power supplies of a rail mounted power system;
identifying a maximum power output of a power distribution unit of the rail mounted power system; and
making a determination, based on the maximum power output and the aggregate power draw, regarding whether the aggregate power draw exceeds the maximum power output; and
in a first instance of the determination where the maximum power output is exceeded:
ranking, with regard to one another and based on priority rankings, each chassis that draws power from any of the power supplies to obtain a rank ordering of the chassis;
identifying, based on the rank ordering, a lowest ranked one of the chassis; and
throttling the lowest ranked one of the chassis to prevent the maximum power output from being exceeded to provide computer implemented services using a portion of the chassis; and
in a second instance of the determination where the maximum power output is not exceeded:
providing the computer implemented services using all of the chassis.

13. The non-transitory machine-readable medium of claim 12, wherein a priority ranking of the priority rankings is based on, at least:
workloads being performed by the power supply free chassis;
types of the workloads;
lifecycle phases of the workloads of at least one of the types of the workloads; and
a scoring system usable to quantify a cost for reperforming the workloads.

14. The non-transitory machine-readable medium of claim 13, wherein the lifecycle phases are one of an enumerated number of phases of artificial intelligence workloads.

15. The non-transitory machine-readable medium of claim 14, wherein the enumerated number of phases comprises:
a training phase;
an inferencing phase; and
an updating phase.

16. The non-transitory machine-readable medium of claim 15, wherein ranking each chassis comprises:
obtaining a roster of available chassis;
obtaining priority ranking; and
ordering the chassis based on point values for each chassis using the priority ranking to obtain the rank ordering.

17. A data processing system, comprising:
a processor; and
a memory coupled to the processor to store instructions, which when executed by the processor, cause the processor to perform operations for managing performance of workloads by hardware components housed in power supply free chassis of a rack system, the operations comprising:
obtaining an aggregate power draw of power supplies of a rail mounted power system;
identifying a maximum power output of a power distribution unit of the rail mounted power system; and
making a determination, based on the maximum power output and the aggregate power draw, regarding whether the aggregate power draw exceeds the maximum power output; and
in a first instance of the determination where the maximum power output is exceeded:
ranking, with regard to one another and based on priority rankings, each chassis that draws power from any of the power supplies to obtain a rank ordering of the chassis;
identifying, based on the rank ordering, a lowest ranked one of the chassis; and
throttling the lowest ranked one of the chassis to prevent the maximum power output from being exceeded to provide computer implemented services using a portion of the chassis; and
in a second instance of the determination where the maximum power output is not exceeded:
providing the computer implemented services using all of the chassis.

18. The data processing system of claim 17, wherein a priority ranking of the priority rankings is based on, at least:
workloads being performed by the power supply free chassis;
types of the workloads;
lifecycle phases of the workloads of at least one of the types of the workloads; and
a scoring system usable to quantify a cost for reperforming the workloads.

19. The data processing system of claim 18, wherein the lifecycle phases are one of an enumerated number of phases of artificial intelligence workloads.

20. The data processing system of claim 19, wherein the enumerated number of phases comprises:
a training phase;
an inferencing phase; and
an updating phase.
